(19) United States
(12) Patent Application Publication
(10) Pub. No.: US 2005/0043973 A1
(43) Pub. Date: Feb. 24, 2005

(54) Projector reservation system and method

(76) Inventor: Winthrop Childers, San Diego, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/645,185

(22) Filed: Aug. 21, 2003

(51) Int. Cl. G06F 17/60

(52) U.S. Cl. 705/5

(57) ABSTRACT

A method and system of requesting a projector and presentation venue reservation is provided. The requesting includes selecting a presentation venue having one or more available projectors and in accordance with venue selection criteria for a given presentation, selecting a projector according to projector selection criteria for the presentation and the one or more projectors available at the venue, selecting a level of security for storing the presentation data to protect the presentation data from unauthorized access and uploading the presentation data to a reservation system server via the network. Coordinating a projector and presentation venue reservation includes receiving a projector and presentation venue reservation request, downloading presentation data from a projector reservation client, ensuring availability of presentation software compatible with the presentation data and commencing a presentation including presentation data.

### BACKGROUND

The present invention relates to digital projectors.

The modem digital projector has effectively revolutionized the art of presentation before both large and small audiences. The presenter can create professional-looking presentations with the aid of specialized software programs running on a conventional personal computer and immediately display them using the digital projector. Virtually anything that can be shown on a computer's display screen can now be projected before an audience.

The digital projector is comprised of a number of components including a high-intensity light source, an image modulator for creating an image by spatially modulating the light source, an electronic interface between the image modulator and the computer supplying the image, and a lens system for focusing and projecting the image.

As previously described, there currently are many software programs available that are designed specifically to create presentations to be shown by a digital projector. In addition to facilitating the creation of professional-looking graphical compositions, these programs also manage the sorting and arrangement of the presentation elements. Animation effects along with the inclusion of video elements are provided for as well.

Although the digital projector and the presentation software programs have provided significant advantages to presenters, unfortunately, there still remain a number of unresolved problems with projector use. These problems are generally related to hardware compatibility, portability and transportation, software compatibility, and media compatibility.

Hardware compatibility is a growing problem due to the wide variety of digital projectors and laptop personal computers available and in use. Most problematic are the many different screen sizes and screen aspect ratios used by these various devices. Digital projectors and laptop computers measure their screen sizes in discrete picture elements termed “pixels.” Often, a laptop computer connected to a digital projector does not work properly due to the disparity of display sizes, aspect ratios, or other technical specifications. For example, a laptop computer with a large screen size may have problems correctly displaying images if a digital projector has a smaller screen size than the laptop.

Currently, many people overcome these compatibility problems by always using a specific projector and laptop computer known to work together. Of course, while digital projectors and laptop computers are portable, carrying the pair on a business trip can be inconvenient due to their bulk and weight. Moreover, security regulations at airports have made carrying equipment such as a digital projector even more problematic.

Software compatibility presents another set of problems. The presenter who wishes to travel lightly may carry the presentation data on either a compact disc or a floppy disc to the presentation venue. Current presentation software does not ensure compatibility with other versions or releases. Often, presentations created with a later version of a software program cannot be displayed by an earlier version of the same program.

Aside from the software compatibility issues, there are also problems of media compatibility and format compatibility. For example, presentations created on one brand of computer and stored on a compact disc might not be readable by the compact disc player on another brand of computer. Or, in another example, a given venue might not have a floppy disc drive installed in its computer, making it impossible to read any presentation data brought to the venue on a floppy disc.

Furthermore, projector use at large conferences and other venues has an added requirement, as many presenters must use the same projector according to a strict time schedule. There is often a significant delay incurred between each presentation due to disconnecting the previous speaker's computer from the projector and then connecting the next speaker's computer and verifying its operation. This can be quite distracting to the audience. The frequent connecting and disconnecting of cables may cause accelerated wear on the digital projector's interface connector and possibly lead to subsequent reliability problems.

There is a need to address at least the aforementioned problems and develop a projector and system that is easier to use.

### BRIEF DESCRIPTION OF THE DRAWINGS

FIG. 1 is a block diagram illustrating a system organization of the projector reservation system in accordance with one implementation of the present invention;

FIG. 2 is a flowchart diagram of the operations pertaining to selecting a projector and presentation venue in accordance with one implementation of the present invention;

FIG. 3 is a flowchart diagram of the operations pertaining to the reservation system server in accordance with one implementation of the present invention; and

FIG. 4 is a flowchart diagram of the operations to ensure availability of the proper presentation software in accordance with one implementation of the present invention.

Like reference numbers and designations in the various drawings indicate like elements.

### SUMMARY OF THE INVENTION

One aspect of the present invention includes a projector reservation system. The system includes a reservation system server capable of communicating over a network with a client that fulfils projector and venue reservation requests received via the network and coordinates the transport and storage of presentation data received via the network. One or more projector systems capable of communicating with the reservation system server download the presentation data for display according to the projector and venue reservation requests.

Another aspect of the present invention features a method of requesting a projector and presentation venue reservation. The requesting includes selecting a presentation venue having one or more available projectors and in accordance with venue selection criteria for a given presentation, selecting a projector according to projector selection criteria for the presentation and the one or more projectors available at the venue, selecting a level of security for storing the presentation data to protect the presentation data from unauthorized access and uploading the presentation data to a reservation system server via the network.

Yet another aspect of the present invention includes coordinating a projector and presentation venue reservation. The coordination includes receiving a projector and presentation venue reservation request, downloading presentation data from a projector reservation client, ensuring availability of presentation software compatible with the presentation data and commencing a presentation including presentation data.

### DETAILED DESCRIPTION

Aspects of the present invention are advantageous in at least one or more of the following ways. Implementations of the present invention enable a presenter to reserve a presentation venue along with a digital projector, transport the presentation data to the venue via a network, and receive assurance that the presentation data along with the necessary presentation software will be available at the venue at the specified date and time according to the reservation. Traveling to a presentation venue without the encumbrance of a digital projector and personal computer is highly advantageous to the harried business traveler or other people who need to travel lightly.

In addition to physically disencumbering the presenter, implementations of the present invention assure a consistent presentation interface. A business traveler using the projector system in one venue can expect the projector system to work similarly in another venue. Further, if the projector is essentially the same from one venue to another, both the business traveler and support staff will be more familiar with the equipment.

At venues, such as academic conferences, where multiple presenters share the same digital projector according to a strict time schedule, the time previously wasted changing from one presenter to the next is eliminated. With the present invention, the next presentation is ready to start as soon as the previous one is finished. Valuable time is not wasted changing cables from one laptop computer to another or loading the next presentation from a portable medium such as a compact disc.

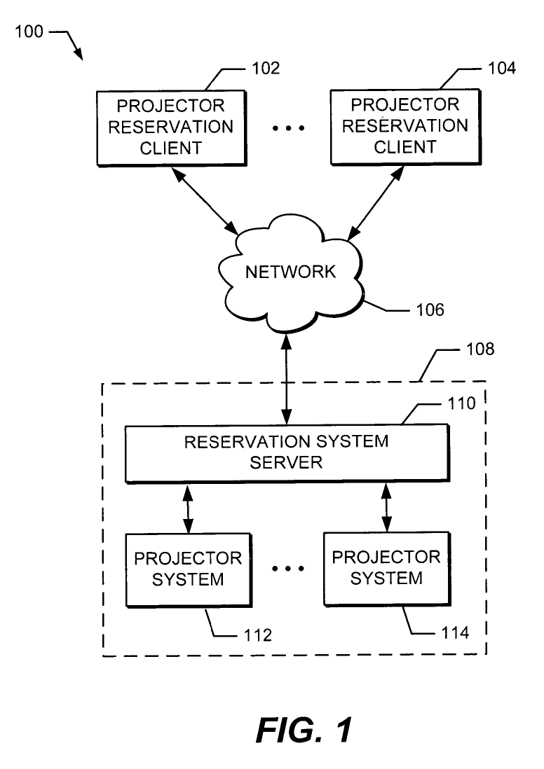

FIG. 1 is a block diagram 100 of a projector reservation system according to one implementation of the present invention. A projector reservation system 100 includes one or more projector reservation clients 102, 104, and a network 106 for communicating with a reservation system server 110. Projector systems 112, 114 and reservation system server 110 are associated with a physical locale 108 such as a hotel or conference center.

In one implementation, a projector reservation client 102 includes a computer equipped with an Internet browser. The computer can be a laptop or desktop computer having a high-speed network connection and running one or more different operating systems including Windows, Linux, or various Unix variants. The Internet browser displays a series of screens to interact with the user in making a projector and venue reservation over network 106. In one implementation, the client can be coded using XML, HTML, Java Script, or other Web-based languages that interact with an Internet browser.

Physical locale 108 typically includes a reservation system server 110 and projector systems 112 through 114 in one or more different venues. Each venue in physical locale 108 can be described as a specific desired combination of one or more projector systems in one or more specific presentation areas with a particular desired seating capacity. In addition, physical locale 108 may also have other characteristics and amenities interesting to the presenter including transportation (i.e., proximity to airport, bus, train), total seating capacity and any other amenities specified by the presenter. Reservation system server 110 can be a large computer server running one of the previously mentioned operating systems and software designed in accordance with the present invention. Aside from a processor, random access memory, and mass storage, reservation system server 110 has sufficient high-speed input/output capacity to communicate with projector systems 112 through 114 and deliver, when appropriate, large presentation data sets.

In operation, projector reservation client 102 reserves one of projector systems 112 through 114 by communicating over a network 106, such as the Internet, with a reservation system server 110. For example, projector reservation client 102 selects physical locale 108 and venue based upon a specific city, hotel or conference center. The venue in physical locale 108 is selected based upon the size (i.e., seating capacity) and availability of projectors as more than one projector may be reserved for a single venue. A Web page graphically displays the availability of projector system 112 in the physical locale 108 and venue. After the reservation process has been completed and payment, if any, received, the Web page guides the uploading of the presenter's data to the reservation system server 110.

Security for uploaded presentation data is provided for by either password protecting the relevant files or by first encrypting the data on the projector reservation client 102 before they are uploaded to the reservation system server 110. Later, when the presentation data is required, it can be accessed via a password entered at one of the venue's projector systems 112. If the data had been previously encrypted, it can be decrypted on the projector system by entering the decryption key at the projector system 112.

Typically, reserving the projector and uploading of the presentation data to the reservation system server 110 take place sometime prior to the actual presentation. During this time, the presenter's data is stored on the reservation system server 110 where its physical security can be more readily assured. On the day of presentation or during some other predetermined period, the presentation data is downloaded to the projector system 112 in response to either receiving either a password or decryption key entered at the projector system 112.

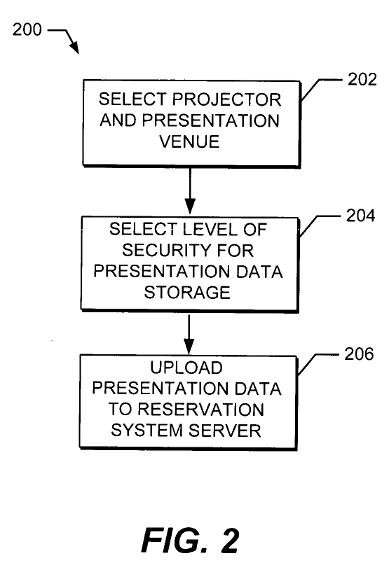

FIG. 2 is a flowchart diagram 200 of the operations of selecting a projector and presentation venue by a projector reservation client in accordance with one implementation of the present invention. First, the projector and presentation venue are selected (202). Selection of the venue can be influenced by a number of criteria such as city, location within the city, seating capacity, screen size, digital projector availability, sound system characteristics, and hotel room availability. Furthermore, additional projector criteria may need to be considered because the projector choice may be critical for some presentations. These additional criteria include, for example, display size in pixels, projected image brightness, color fidelity, and lens system capable of zooming. For example, these additional projector criteria may be necessary when presenting detailed graphs or high-resolution color images requiring special projection equipment.

After selecting and reserving the projector and venue, the level of security for the presentation data is selected (204). This is necessary in order to protect the presentation data from unauthorized access such as accidental deletion, theft, or malicious mischief. Nominal protection can be assured by password protection of the uploaded presentation data file. More secure protection can be afforded by encryption of the presentation data before uploading to the reservation system server. Alternative implementations may operate without security thereby allowing general access to the presentation data.

After the level of security for the presentation data storage has been selected, the presentation data is uploaded to the reservation system server (206). The uploaded data will remain on the server until it is required at the time of presentation, thus affording the data greater physical security. In some cases, it may be more convenient to the projector reservation client to upload the presentation data at some arbitrary time other than the time of making the actual reservation. For example, to avoid congestion during busy periods, the data can be uploaded during an off-peak window of time.

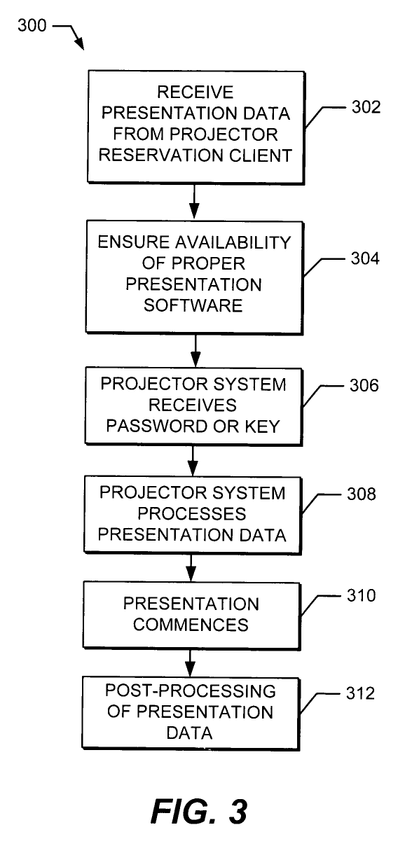

FIG. 3 is a flowchart diagram 300 of the operation associated with the reservation system server in accordance with one implementation of the present invention. After the projector and venue have been reserved, the presentation data is received from the projector reservation client (302). The presentation data is typically comprised of a data file created by a specialized presentation software program. This software facilitates the creation of professional-looking graphics and aids in the sorting and arranging the presentation elements.

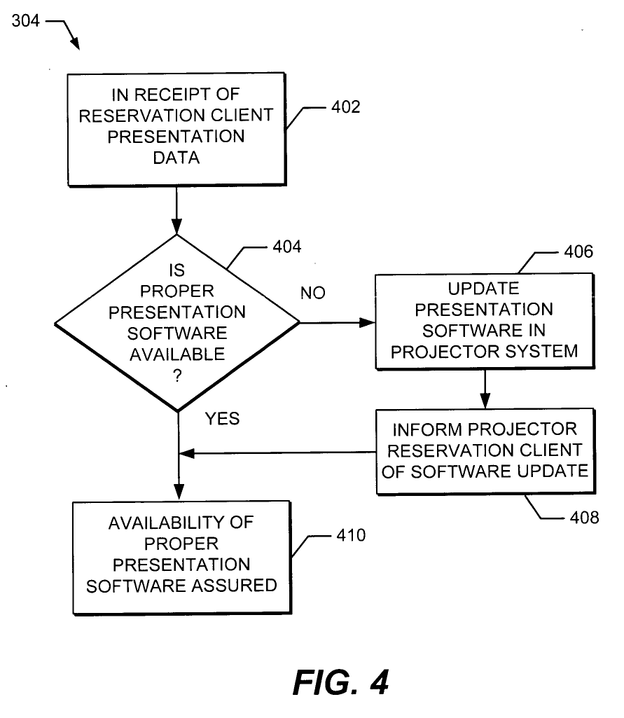

Implementations of the present invention also ensure availability of proper presentation software (304). In many cases, it is not sufficient to simply verify that the same make of program that created the presentation data is installed. Manufactures of software for presentations and other purposes are constantly adding new features to their programs and as a consequence, data formats may change. Often, a presentation made with newer software cannot be properly displayed with an older version of the same program. Further details of this operation are described later herein with respect to FIG. 4.

The presentation data can be stored on either the projector system or the reservation system server until it is needed at the presentation venue. However, as previously described, storage on the reservation system server generally provides greater physical security for the data. In preparation for the presentation, the projector system receives either a password or decryption key (306) in order to download the presentation data from the reservation system server to the projector system. The password can be entered via a keyboard associated with the projector system. The decryption key can be supplied by a portable medium including a floppy disc, compact disc, or flash memory. Alternatively, biometric security measures can be used to authenticate and authorize access to the presentation data. These may include iris scanning, fingerprint recognition, voice identification, or any other suitable biometric measure.

After receipt of either the password or decryption key (306), the projector system processes the presentation data (308). Typically, this involves matching the presentation data to the proper presentation software and then starting the presentation software program.

Once the presentation software program has started, the presentation commences (310) using the projector system and other equipment at the venue. A presentation typically comprises reading the stored presentation data, converting the presentation data to graphic images, and projecting the graphic images via a digital projector. Presentations ordinarily involve only a single projector and screen where the presenter controls advancement from one presentation “slide” to the next. However, more elaborate presentations can comprise multiple screens and projectors under automatic control.

At the conclusion of the presentation, the reservation system server oversees the post-processing of the presentation data (312). Post-processing of the presentation data ensures data security by rendering the data unrecoverable. Typically, when data is “deleted” from a personal computer, only the pointer to the data file on the hard disc is erased and the actual data remains on the disc. To render data unrecoverable, it is physically obliterated. This is accomplished by writing random data over the original data. To ensure data security, all copies of the presentation data must be rendered unrecoverable wherever they are stored. This includes copies on the reservation system server, on the projector system and on any backup media. Additionally, post-processing of the data may include sending via e-mail copies of the presentation to qualified recipients, printing copies of the presentation, or archiving the presentation.

FIG. 4 is a flowchart diagram 304 of the operations to ensure availability of the proper presentation software for use with the presentation data supplied by the projector reservation client in accordance with one implementation of the present invention. The process begins with the reservation system server in receipt of the reservation client presentation data (402). At this point, the software and its version number, responsible for the creation of the presentation data are ascertained.

After ascertaining the software required by projector reservation client, a check is made to determine if the proper presentation software is available (404). In this case, “available” means that the software is resident on the reservation system server and can be downloaded to the reserved projector system. If the software is available, then the availability of the proper presentation software is assured (410). Assurance can be provided to the reservation client in the form of a Web page indication that the necessary software is available or as part of an e-mail reservation confirmation.

If the software is not available, then the presentation software in the projector system will be updated (406). In general, the presentation software can be quickly updated by automatically downloading the latest version of a program from the software manufacturer over the Internet or other network. In special cases, an update may require the purchase of a new software package. In the event that the necessary software cannot be obtained in time for the reservation, the reservation client is notified by e-mail that the required software is not available and cannot be obtained.

After the presentation software has been updated, the projector reservation client is informed of the software update (408). The notification may take the form of a Web page indication or as part of an e-mail reservation confirmation. At this point, availability of the proper presentation software is assured (410). The presenter can now proceed unencumbered to the venue with confidence, knowing that the presentation data, necessary presentation software, projector system, and presentation venue will all be available according to the reservation.

While examples and implementations have been described, they should not serve to limit any aspect of the present invention. Accordingly, versions of the present invention can be implemented in digital or analog electronic circuitry, or in computer hardware, firmware, software, or in combination therein.

Furthermore, while specific embodiments have been described herein for the purposes of illustration, various modifications may be made without departing from the spirit and scope of the invention. Accordingly, the invention is not limited to the above-described implementations, but instead is defined by the appended claims in light of their full scope of equivalents.

1. A projector reservation system, comprising:
a reservation system server capable of communicating over a network with a client that fulfils projector and venue reservation requests received via the network and coordinates the transport and storage of presentation data received via the network; and
one or more projector systems capable of communicating with the reservation system server that download the presentation data for display according to the projector and venue reservation requests.

2. The system of claim 1 wherein the uploaded presentation data is stored with password protection.

3. The system of claim 1 wherein the uploaded presentation data is stored with encryption protection.

4. The system of claim 1 wherein the uploaded presentation data is stored with biometric verification protection including iris scan, fingerprint recognition, or voice identification.

5. The system of claim 1 wherein the reservation system server comprises a computer including a processor, random access memory, network interface, and mass storage device.

6. The system of claim 1 wherein the projector system comprises a digital projector communicating with a computer including a processor, random access memory, and mass storage device.

7. The system of claim 1 wherein the network comprises the Internet.

8. A method of requesting a projector and presentation venue reservation, comprising:
selecting a presentation venue having one or more available projectors and in accordance with venue selection criteria for a given presentation;
selecting a projector according to projector selection criteria for the presentation and the one or more projectors available at the venue;
selecting a level of security for storing the presentation data to protect the presentation data from unauthorized access; and
uploading the presentation data to a reservation system server via the network.

9. The method of claim 8 wherein the venue selection criteria includes at least one criterion chosen from a group of criteria including city, location within the city, seating capacity, screen size, digital projector availability, sound system characteristics, and hotel room availability.

10. The method of claim 8 wherein the projector selection criteria include display size in pixels, projected image brightness, color fidelity, and lens system capable of zooming.

11. The method of claim 8 wherein the security level includes password protection.

12. The method of claim 8 wherein the security level includes encryption protection.

13. The method of claim 8 wherein the security level includes protection by biometric verification including iris scan, fingerprint recognition, or voice identification.

14. The method of claim 8 wherein the presentation data uploading can take place at an arbitrary time

15. A method of coordinating a projector and presentation venue reservation, comprising:
receiving a projector and presentation venue reservation request;
downloading presentation data from a projector reservation client;
ensuring availability of presentation software compatible with the presentation data; and
commencing a presentation including presentation data.

16. The method of claim 15 further comprising receiving a password, decryption key, or biometric verification to access presentation data.

17. The method of claim 15 further comprising post-processing of presentation data.

18. The method of claim 15 wherein the uploaded presentation data is stored on the reservation system server.

19. The method of claim 15 wherein the uploaded presentation data is stored on a projector system.

20. The method of claim 15 wherein ensuring the availability of proper presentation software, comprises:
determining if presentation software compatible with the presentation data is loaded and available for use; and
updating the presentation software to a version compatible with the presentation data.

21. The method of claim 20 further comprising depending upon the determination, informing the projector reservation client of presentation software update; and

22. The method of claim 20 further comprising assuring the projector reservation client of proper presentation software availability.

23. The method of claim 15 wherein the password is entered via a keyboard associated with the projector system.

24. The method of claim 15 wherein the decryption key is supplied by a portable medium including a floppy disc, compact disc, or flash memory.

25. The method of claim 15 wherein biometric verification includes iris scan, fingerprint recognition, or voice identification.

26. The method of claim 15 wherein commencing the presentation includes reading the stored presentation data, converting the presentation data to graphic images, and projecting the graphic images via a digital projector.

27. The method of claim 15 wherein post-processing of the presentation data comprises rendering the presentation data unrecoverable.

28. The method of claim 15 wherein the updating further comprises purchasing the software version compatible the presentation data.

29. An apparatus for a projector reservation system, comprising:
means for selecting a presentation venue according to the criteria for a given presentation;
means for selecting a projector according to the criteria of the presentation and the projectors available at the venue;
means for selecting a level of security for presentation data storage to protect the presentation data from unauthorized access; and
means for uploading presentation data to the reservation system server via the network.

30. An apparatus for coordinating a projector reservation system and presentation, comprising:
means for receiving presentation data from a projector reservation client;
means for ensuring availability of proper presentation software;
means for receiving a password, decryption key, or biometric verification for accessing presentation data; and
means for commencing a presentation of the presentation data.

31. A computer program product for controlling a projector reservation system, tangibly stored on a computer-readable medium, comprising instructions operable to cause a programmable processor to:
select a presentation venue;
select a projector;
coordinate uploading, security, and storage of presentation data;
coordinate delivery of presentation data to the projector system at the time and date specified by the reservation; and
coordinate the presentation or the presentation data.

32. The computer program of claim 31 further comprising assuring the availability of the proper presentation software for the uploaded presentation data.

33. The computer program of claim 31 further comprising performing post-processing on the presentation data after the presentation.
